(19) United States
(12) Patent Application Publication
(10) Pub. No.: US 2021/0341809 A1
(43) Pub. Date: Nov. 4, 2021

(54) DISPLAY PANEL AND DISPLAY DEVICE

(71) Applicant: SEMICONDUCTOR ENERGY LABORATORY CO., LTD., ATSUGI-SHI, KANAGAWA-KEN (JP)

(72) Inventors: Shunpei YAMAZAKI, Setagaya, Tokyo (JP); Tetsuji ISHITANI, Atsugi, Kanagawa (JP)

(73) Assignee: SEMICONDUCTOR ENERGY LABORATORY CO., LTD., ATSUGI-SHI, KANAGAWA-KEN (JP)

(21) Appl. No.: 17/266,795

(22) PCT Filed: Aug. 8, 2019
(86) PCT No.: PCT/IB2019/056743

§ 371 Date: Feb. 8, 2021

(30) Foreign Application Priority Data
Aug. 23, 2018 (JP) 2018-156378

(51) Int. Cl. G02F 1/1362; G09G 3/36

(52) U.S. Cl. CPC G02F 1/136286; G09G 3/3688

(57) ABSTRACT

A novel display panel that is highly convenient or reliable is provided. The display panel includes a first display area, a second display area, a first margin area, and a second margin area. The second display area is arranged continuously with the first display area; the first margin area is adjacent to the first display area; the second margin area is adjacent to the second display area; and the second margin area faces the first margin area. The first display area includes a pixel; the pixel includes a pixel circuit and a display element; the display element is electrically connected to the pixel circuit; and the display element has a function of transmitting or scattering incident light.

### TECHNICAL FIELD

One embodiment of the present invention relates to a display panel, a display device, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Thus, more specifically, examples of the technical field of one embodiment of the present invention disclosed in this specification include a semiconductor device, a display device, a light-emitting device, a power storage device, a memory device, a driving method thereof, and a manufacturing method thereof.

### BACKGROUND ART

Known is a display device including a first substrate having a light-transmitting property; a second substrate facing the first substrate and having a light-transmitting property; a light-modulation layer arranged between the first substrate and the second substrate; a light source unit that illuminates the light-modulation layer from an outer side of a position that faces, along a normal direction, a display area displaying an image; first to third color filters having different colors of red, green, and blue, respectively, which are arranged on the first substrate; and first to third electrodes facing the first to third color filters, respectively, in which the light-modulation layer is capable of changing the light dispersibility of regions facing the first to third color filters according to an electric field generated by the corresponding one of the first to third electrodes (Patent Document 1).

### REFERENCE

### Patent Document

[Patent Document 1] United States Patent Application Publication No. 2018/0024403

### SUMMARY OF THE INVENTION

### Problems to be Solved by the Invention

An object of one embodiment of the present invention is to provide a novel display panel that is highly convenient or reliable. Another object is to provide a novel display device that is highly convenient or reliable. Another object is to provide a novel display panel, a novel display device, or a novel semiconductor device.

Note that the description of these objects does not preclude the existence of other objects. One embodiment of the present invention does not have to achieve all these objects. Other objects are apparent from and can be derived from the description of the specification, the drawings, the claims, and the like.

### Means for Solving the Problems

(1) One embodiment of the present invention is a display panel including a first display area, a second display area, a first margin area, and a second margin area.

The second display area is arranged continuously with the first display area.

The first margin area is adjacent to the first display area.

The second margin area is adjacent to the second display area and the second margin area faces the first margin area.

The first display area includes a pixel and the pixel includes a pixel circuit and a display element.

The display element is electrically connected to the pixel circuit and the display element has a function of transmitting or scattering incident light.

Thus, a continuous image can be displayed on the first display area and the second display area. The display area can have a light-transmitting property by using a state of transmitting incident light and a state of scattering incident light. As a result, a novel display panel that is highly convenient or reliable can be provided.

(2) One embodiment of the present invention is the aforementioned display element, which includes a first electrode, a second electrode, a layer containing a liquid crystal material, a first alignment film, and a second alignment film.

The first alignment film includes a region positioned between the first electrode and the layer containing a liquid crystal material, and the second alignment film includes a region positioned between the second electrode and the layer containing a liquid crystal material.

The second electrode is arranged so that an electric field crossing the layer containing a liquid crystal material is formed between the first electrode and the second electrode.

The layer containing a liquid crystal material scatters incident light with a first scattering intensity when the electric field is in a first state. The layer containing a liquid crystal material scatters the incident light with a second scattering intensity when the electric field is in a second state where the electric field is stronger than that in the first state. Note that the second scattering intensity is higher than the first scattering intensity.

The layer containing a liquid crystal material contains a liquid crystal material and a high molecular material and is stabilized with a polymer.

The high molecular material is a copolymer of a polyfunctional monomer and a monofunctional monomer; the polyfunctional monomer has a phenyl benzoate skeleton; and the monofunctional monomer has a cyclohexylbenzene skeleton.

Thus, incident light can be scattered more strongly in a second electric field intensity that is higher than a first electric field intensity. The power consumed in the state of easily transmitting incident light can be reduced. As a result, a novel display panel that is highly convenient or reliable can be provided.

(3) One embodiment of the present invention is the aforementioned display panel in which the second scattering intensity is 10 times or more the first scattering intensity.

Thus, the contrast between the state of transmitting incident light and the state of scattering incident light can be increased. As a result, a novel liquid crystal element that is highly convenient or reliable can be provided.

(4) One embodiment of the present invention is a display panel including a display area.

The display area includes a group of pixels, a different group of pixels, a scan line, and a signal line.

The group of pixels includes the pixel and is arranged in a row direction.

The different group of pixels includes the pixel and is arranged in a column direction intersecting the row direction.

The scan line is electrically connected to the group of pixels. The signal line is electrically connected to the different group of pixels.

Thus, image data can be supplied to a plurality of pixels. The image data can be displayed. As a result, a novel display panel that is highly convenient or reliable can be provided.

(5) One embodiment of the present invention is a display device including the aforementioned display panel and a control unit.

Image data and control data are supplied to the control unit. The control unit generates data on the basis of the image data, and generates a control signal on the basis of the control data.

The control unit supplies the data and the control signal.

The data and the control signal are supplied to the display panel. The display panel includes a driver circuit, and the driver circuit operates on the basis of the control signal. The pixel performs display on the basis of the data.

Thus, the image data can be displayed using a display element. As a result, a novel display device that is highly convenient or reliable can be provided.

In the drawings attached to this specification, the block diagram in which components are classified according to their functions and shown as independent blocks is shown; however, it is difficult to completely separate actual components according to their functions, and it is possible for one component to relate to a plurality of functions.

In this specification, the names of a source and a drain of a transistor interchange with each other depending on the polarity of the transistor and the levels of potentials applied to the terminals. In general, in an n-channel transistor, a terminal to which a lower potential is applied is called a source, and a terminal to which a higher potential is applied is called a drain. In a p-channel transistor, a terminal to which a lower potential is applied is called a drain, and a terminal to which a higher potential is applied is called a source. In this specification, for the sake of convenience, the connection relation of a transistor is sometimes described assuming that the source and the drain are fixed; in reality, the names of the source and the drain interchange with each other according to the above relation of the potentials.

In this specification, a source of a transistor means a source region that is part of a semiconductor film functioning as an active layer or a source electrode connected to the semiconductor film. Similarly, a drain of a transistor means a drain region that is part of the semiconductor film or a drain electrode connected to the semiconductor film. Moreover, a gate means a gate electrode.

In this specification, a state where transistors are connected in series means, for example, a state where only one of a source and a drain of a first transistor is connected to only one of a source and a drain of a second transistor. In addition, a state where transistors are connected in parallel means a state where one of a source and a drain of a first transistor is connected to one of a source and a drain of a second transistor and the other of the source and the drain of the first transistor is connected to the other of the source and the drain of the second transistor.

In this specification, connection means electrical connection and corresponds to a state where a current, a voltage, or a potential can be supplied or transmitted. Accordingly, a state of being connected does not necessarily mean a state of being directly connected and also includes, in its category, a state of being indirectly connected through a circuit element such as a wiring, a resistor, a diode, or a transistor that allows a current, a voltage, or a potential to be supplied or transmitted.

In this specification, even when independent components are connected to each other in a circuit diagram, there is actually a case where one conductive film has functions of a plurality of components such as a case where part of a wiring functions as an electrode, for example. Connection in this specification also includes such a case where one conductive film has functions of a plurality of components, in its category.

In this specification, one of a first electrode and a second electrode of a transistor refers to a source electrode and the other refers to a drain electrode.

### Effect of the Invention

According to one embodiment of the present invention, a novel display panel that is highly convenient or reliable can be provided. According to another embodiment of the present invention, a novel display device that is highly convenient or reliable can be provided. According to another embodiment of the present invention, a novel liquid crystal element, a novel display panel, a novel display device, or a novel semiconductor device can be provided.

Note that the description of these effects does not preclude the existence of other effects. One embodiment of the present invention does not need to have all these effects. Other effects are apparent from and can be derived from the description of the specification, the drawings, the claims, and the like.

### BRIEF DESCRIPTION OF THE DRAWINGS

FIG. 1A to FIG. 1D are diagrams illustrating structures of a display panel according to an embodiment.

FIG. 2A and FIG. 2B are diagrams illustrating structures of a liquid crystal element according to an embodiment.

FIG. 3A and FIG. 3B are diagrams illustrating structures of a display panel according to an embodiment.

FIG. 4A to FIG. 4C are a cross-sectional view and circuit diagrams illustrating structures of a display panel according to an embodiment.

FIG. 5A and FIG. 5B are cross-sectional views illustrating structures of a display panel according to an embodiment.

FIG. 6A and FIG. 6B are cross-sectional views illustrating structures of a display panel according to an embodiment.

FIG. 7 is a diagram illustrating a structure of a display panel according to an embodiment.

FIG. 8A and FIG. 8B1 to FIG. 8B3 are diagrams illustrating structures of a display device according to an embodiment.

FIG. 9A to FIG. 9D are diagrams illustrating structures of data processing devices of an embodiment.

FIG. 10A and FIG. 10B are diagrams illustrating structures of data processing devices of an embodiment.

### MODE FOR CARRYING OUT THE INVENTION

One embodiment of the present invention is a display panel including a first display area, a second display area, a first margin area, and a second margin area. The second display area is arranged continuously with the first display area; the first margin area is adjacent to the first display area; the second margin area is adjacent to the second display area; and the second margin area faces the first margin area. The first display area includes a pixel; the pixel includes a pixel circuit and a liquid crystal element; the liquid crystal element is electrically connected to the pixel circuit; and the liquid crystal element has a function of transmitting or scattering incident light.

Thus, a continuous image can be displayed on the first display area and the second display area. The display area can have a light-transmitting property by using a state of transmitting incident light and a state of scattering incident light. As a result, a novel display panel that is highly convenient or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and a description thereof is not repeated.

### Embodiment 1

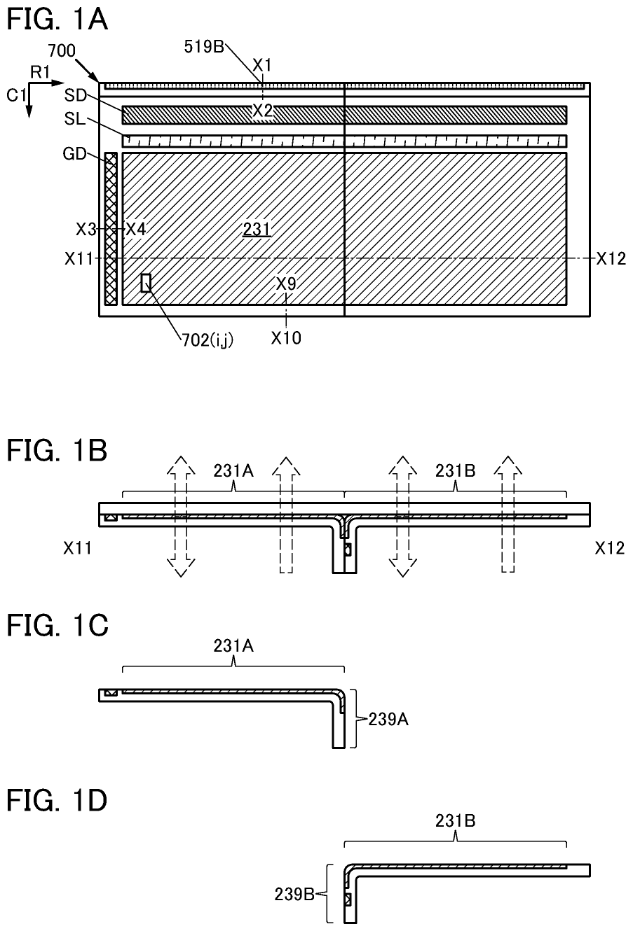

In this embodiment, a structure of a display panel of one embodiment of the present invention will be described with reference to FIG. 1.

FIG. 1A is a top view illustrating the structure of the display panel of one embodiment of the present invention; FIG. 1B, a cross-sectional view along the cutting line X11-X12 in FIG. 1A;

FIG. 1C, a part of FIG. 1B; and FIG. 1D, another part of FIG. 1B.

Note that in this specification, an integer variable of 1 or more is sometimes used in reference numerals. For example, (p) where p is an integer variable of 1 or more is sometimes used in part of a reference numeral that specifies any of up top components. For another example, (m,n) where m and n are each an integer variable of 1 or more is sometimes used in part of a reference numeral that specifies any of up to m×n components.

### <Structure Example of Display Panel 700>

A display panel 700 described in this embodiment includes a display area 231A, a display area 231B, a margin area 239A, and a margin area 239B (see FIG. 1A and FIG. 1B).

The display area 231B is arranged continuously with the display area 231A.

The margin area 239A is adjacent to the display area 231A (see FIG. 1C).

The margin area 239B is adjacent to the display area 231B and the margin area 239B faces the margin area 239A (see FIG. 1B and FIG. 1D).

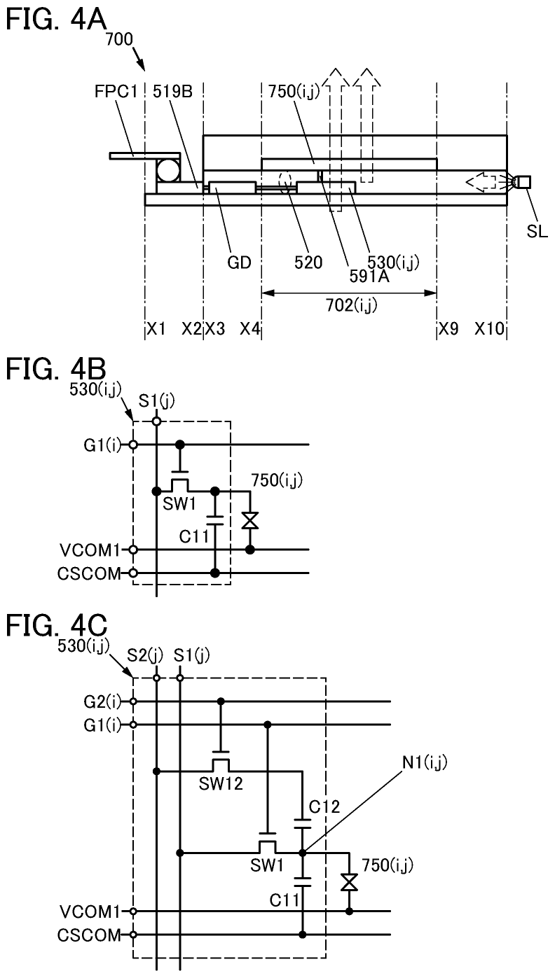

The display area 231A includes a pixel 702(i,j) (see FIG. 1A) and the pixel 702(i,j) includes a pixel circuit 530(i,j) and a display element 750(i,j) (see FIG. 4A).

The display element 750(i,j) is electrically connected to the pixel circuit 530(i,j) and the display element 750(i,j) has a function of transmitting or scattering incident light (see FIG. 4A and FIG. 4C). Note that a light source SL can be used in the display panel, for example.

Thus, a continuous image can be displayed on a first display area and a second display area. The display area can have a light-transmitting property by using a state of transmitting incident light and a state of scattering incident light. As a result, a novel display panel that is highly convenient or reliable can be provided.

### <<Light Source SL>>

An LED or the like can be used as the light source SL. For example, a blue LED, a green LED, and a red LED can be used as the light source SL. Specifically, a light source of simultaneously turning on the blue LED, the green LED, and the red LED to emit white light can be used as the light source SL. Alternatively, a light source of sequentially turning on the blue LED, the green LED, and the red LED to emit white light can be used as the light source SL.

Note that the light source SL can be a light source that turns on the blue LED when a blue component of image data is displayed, that turns on the green LED when a green component of the image data is displayed, and that turns on the red LED when a red component of the image data is displayed. In other words, the image data can be displayed by a field-sequential system.

Note that this embodiment can be combined with the other embodiments in this specification as appropriate.

### Embodiment 2

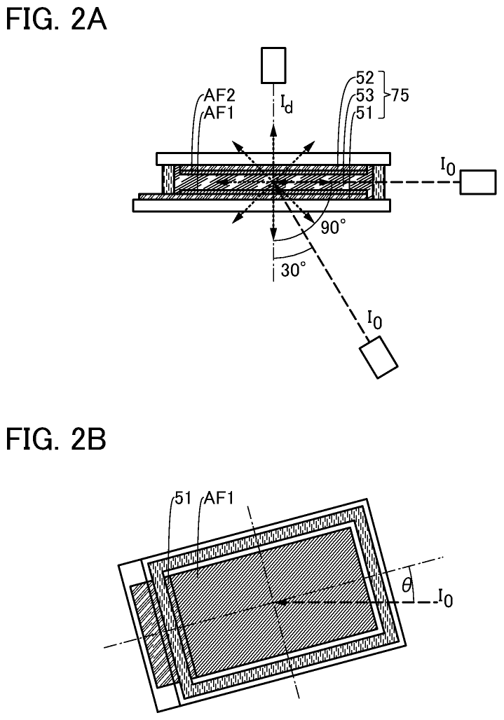

In this embodiment, a structure of a liquid crystal element that can be used in a display panel of one embodiment of the present invention will be described with reference to FIG. 2.

FIG. 2A is a cross-sectional view illustrating the structure of the liquid crystal element that can be used in the display panel of one embodiment of the present invention, and FIG. 2B is a top view illustrating the structure of the liquid crystal element that can be used in the display panel of one embodiment of the present invention.

### <Structure Example 1 of Liquid Crystal Element>

A liquid crystal element 75 described in this embodiment includes an electrode 51, an electrode 52, and a layer 53 containing a liquid crystal material. The liquid crystal element 75 also includes an alignment film AF1 and an alignment film AF2 (see FIG. 2A).

### <<Structure Example of Alignment Film AF1 and Alignment Film AF2>>

The alignment film AF1 includes a region positioned between the electrode 51 and the layer 53 containing a liquid crystal material. The alignment film AF2 includes a region positioned between the electrode 52 and the layer 53 containing a liquid crystal material.

An alignment film for aligning liquid crystals in a substantially horizontal direction can be used as the alignment film AF1 and the alignment film AF2. For example, the pretilt angle can be set to approximately 3° to 5°.

Note that the alignment film AF2 is subjected to rubbing treatment so as to be antiparallel with the alignment film AF1. The thickness of the alignment film AF1 or the alignment film AF2 can be, for example, 70 nm.

### <<Structure Example of Electrode 51 and Electrode 52>>

The electrode 52 is arranged so that an electric field crossing the layer 53 containing a liquid crystal material is formed between the electrode 51 and the electrode 52.

### <<Structure Example 1 of Layer 53 Containing Liquid Crystal Material>>

The layer 53 containing a liquid crystal material scatters incident light I₀ with a first scattering intensity when the electric field is in a first state.

The layer 53 containing a liquid crystal material scatters the incident light I₀ with a second scattering intensity when the electric field is in a second state where the electric field is stronger than that in the first state. Note that the second scattering intensity is higher than the first scattering intensity.

Note that the thickness of the layer 53 containing a liquid crystal material can be, for example, 4 μm.

### <<Structure Example 2 of Layer 53 Containing Liquid Crystal Material>>

The layer 53 containing a liquid crystal material contains a liquid crystal material and a high molecular material and is stabilized with a polymer.

### <<Structure Example of Liquid Crystal Material>>

For example, MDA-00-3506, a liquid crystal material produced by Merck KGaA, can be used for the layer 53 containing a liquid crystal material.

### <<Structure Example of High Molecular Material>>

The high molecular material is a copolymer of a polyfunctional monomer and a monofunctional monomer.

### <<Structure Example of Polyfunctional Monomer>>

The polyfunctional monomer has a phenyl benzoate skeleton. For example, diacrylate having a phenyl benzoate skeleton can be used as the polyfunctional monomer. Specifically, a material represented by the following structural formula (1) can be used as the polyfunctional monomer.

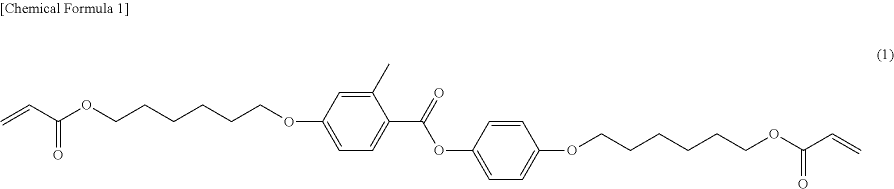 [SMILES: C=CC(=O)OCCCCCCOc1ccc(OC(=O)c2ccc(OCCCCCCOC(=O)C=C)cc2C)cc1]

### <<Structure Example of Monofunctional Monomer>>

The monofunctional monomer has a cyclohexylbenzene skeleton. For example, acrylate having a cyclohexyl skeleton can be used as the monofunctional monomer. Specifically, materials represented by the following structural formula (2) to structural formula (4) can be used as the monofunctional monomer.

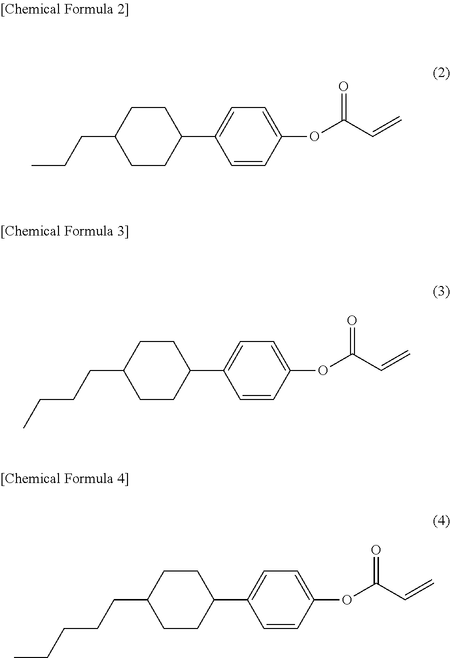

Thus, incident light can be scattered more strongly with the second electric field intensity that is higher than the first electric field intensity. The power consumed in the state of easily transmitting incident light can be reduced. As a result, a novel liquid crystal element that is highly convenient or reliable can be provided.

Note that phenyl benzoate has a structure represented by the structural formula (5) and cyclohexylbenzene has a structure represented by the structural formula (6). Both phenyl benzoate and cyclohexylbenzene may have a substituent.

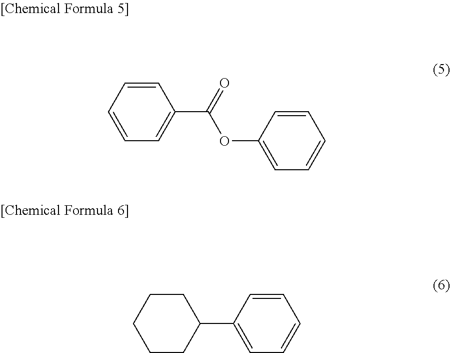 [SMILES: O=C(Oc1ccccc1)c1ccccc1 ; c1ccc(C2CCCCC2)cc1]

### <Structure Example 2 of Liquid Crystal Element>

The second scattering intensity of the liquid crystal element described in this embodiment is 10 times or more the first scattering intensity.

Thus, the contrast between the state of transmitting incident light and the state of scattering incident light can be increased. As a result, a novel liquid crystal element that is highly convenient or reliable can be provided.

Note that this embodiment can be combined with the other embodiments in this specification as appropriate.

### Embodiment 3

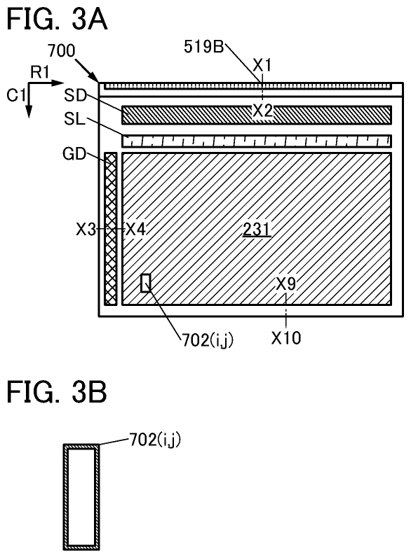

In this embodiment, a structure of a display panel of one embodiment of the present invention will be described with reference to FIG. 3 and FIG. 4.

FIG. 3 illustrates the structure of the display panel of one embodiment of the present invention. FIG. 3A is a top view of the display panel of one embodiment of the present invention, and FIG. 3B is part of FIG. 3A.

FIG. 4 illustrates the structure of the display panel of one embodiment of the present invention. FIG. 4A is a cross-sectional view along the cutting lines X1-X2, X3-X4, and X9-X10 in FIG. 3A, and FIG. 4B and FIG. 4C are circuit diagrams illustrating the pixel circuit 530(i,j).

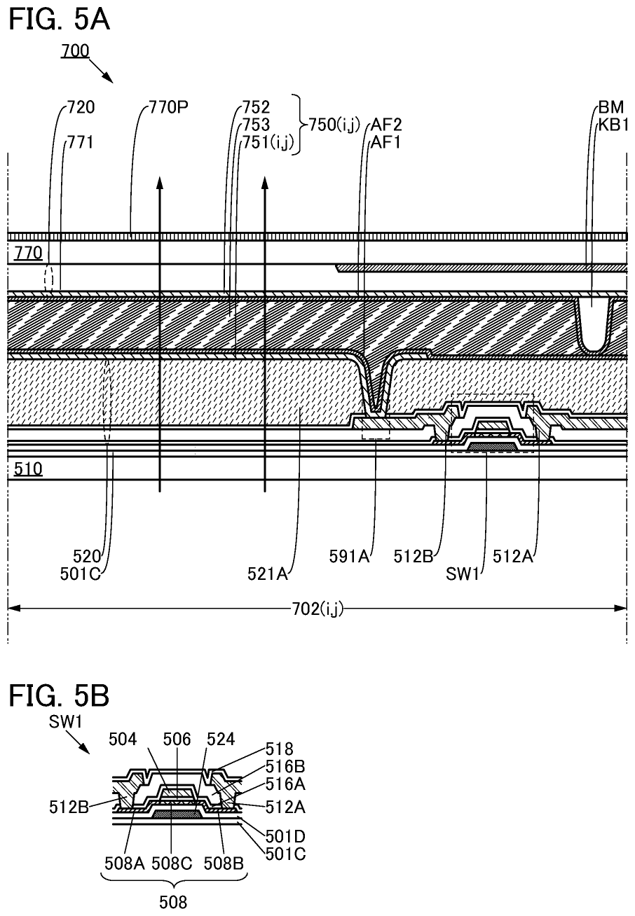

FIG. 5 illustrates the structure of the display panel of one embodiment of the present invention. FIG. 5A is a cross-sectional view of the pixel 702(i,j) in FIG. 3A, and FIG. 5B is a cross-sectional view illustrating part of FIG. 5A.

<Structure example 1 of display panel 700>

The display panel 700 described in this embodiment includes a display area 231 and a functional layer 520 (see FIG. 3A and FIG. 4A).

### <<Structure Example 1 of Display Area 231>>

The display area 231 includes the pixel 702(i,j). The pixel 702(i,j) includes the display element 750(i,j) and the pixel circuit 530(i,j).

<<Structure Example of Pixel 702(i,j)>>

For example, the liquid crystal element 75 described in Embodiment 2 can be used as the display element 750(i,j). The display element 750(i,j) is electrically connected to the pixel circuit 530(i,j).

### <<Structure Example 1 of Functional Layer 520>>

The functional layer 520 includes the pixel circuit 530(i,j). The functional layer 520 has an opening portion 591A. For example, the pixel circuit 530(i,j) is electrically connected to the display element 750(i,j) in the opening portion 591A (see FIG. 4A).

<<Structure Example 1 of Pixel Circuit 530(i,j)>>

The pixel circuit 530(i,j) is electrically connected to a scan line G1(i) (see FIG. 4B).

For example, a switch, a transistor, a diode, a resistor, an inductor, or a capacitor can be used in the pixel circuit 530(i,j). Specifically, a transistor can be used as the switch.

Specifically, the pixel circuit 530(i,j) includes a capacitor C11 and a switch SW1.

### <<Structure Example of Capacitor C11>>

The capacitor C11 includes a first electrode electrically connected to the switch SW1 and a second electrode electrically connected to a wiring CSCOM.

### <<Structure Example of Switch SW1>>

For example, a transistor can be used as the switch SW1.

For example, a bottom-gate transistor or a top-gate transistor can be used in the pixel circuit 530(i,j).

The transistor includes a semiconductor film 508, a conductive film 504, a conductive film 512A, and a conductive film 512B (see FIG. 5B).

The semiconductor film 508 includes a region 508A electrically connected to the conductive film 512B and a region 508B electrically connected to the conductive film 512A. The semiconductor film 508 includes a region 508C between the region 508A and the region 508B.

The conductive film 504 includes a region overlapping with the region 508C, and the conductive film 504 has a function of a gate electrode.

An insulating film 506 includes a region positioned between the semiconductor film 508 and the conductive film 504. The insulating film 506 has a function of a gate insulating film.

The conductive film 512A has one of a function of a source electrode and a function of a drain electrode, and the conductive film 512B has the other of the function of the source electrode and the function of the drain electrode.

A conductive film 524 can be used for the transistor. The semiconductor film 508 is positioned between a region of the conductive film 524 and the conductive film 504. The conductive film 524 has a function of a gate electrode. The conductive film 524 can be electrically connected to, for example, the conductive film 504.

Note that in the step of forming the semiconductor film used in the transistor of the pixel circuit, a semiconductor film used in a transistor of a driver circuit can be formed.

### <<Structure Example 1 of Semiconductor Film 508>>

For example, a semiconductor containing a Group 14 element can be used for the semiconductor film 508. Specifically, a semiconductor containing silicon can be used for the semiconductor film 508.

### [Hydrogenated Amorphous Silicon]

For example, hydrogenated amorphous silicon can be used for the semiconductor film 508. Alternatively, microcrystalline silicon or the like can be used for the semiconductor film 508. Thus, for example, a display panel having less display unevenness than a display panel that uses polysilicon for the semiconductor film 508 can be provided. The size of the display panel can be easily increased.

### [Polysilicon]

For example, polysilicon can be used for the semiconductor film 508. In this case, for example, the field-effect mobility of the transistor can be higher than that of a transistor that uses hydrogenated amorphous silicon for the semiconductor film 508. For another example, the driving capability can be higher than that of a transistor that uses hydrogenated amorphous silicon for the semiconductor film 508. For another example, the aperture ratio of the pixel can be higher than that of a transistor that uses hydrogenated amorphous silicon for the semiconductor film 508.

For example, the reliability of the transistor can be higher than that of a transistor that uses hydrogenated amorphous silicon for the semiconductor film 508.

For example, the temperature required for fabrication of the transistor can be lower than that required for fabrication of a transistor that uses single crystal silicon for the semiconductor film 508.

The semiconductor film used for the transistor in the driver circuit can be formed in the same process as the semiconductor film used for the transistor in the pixel circuit. The driver circuit can be formed over the substrate over which the pixel circuit is formed. The number of components included in an electronic device can be reduced.

### [Single Crystal Silicon]

For example, single crystal silicon can be used for the semiconductor film 508. In this case, for example, the resolution can be higher than that of a display panel that uses hydrogenated amorphous silicon for the semiconductor film 508. For another example, a display panel having less display unevenness than a display panel that uses polysilicon for the semiconductor film 508 can be provided. For another example, smart glasses or a head mounted display can be provided.

### <<Structure Example 2 of Semiconductor Film 508>>

For example, a metal oxide can be used for the semiconductor film 508. Thus, a pixel circuit can hold an image signal for a longer time than a pixel circuit utilizing a transistor that uses amorphous silicon for a semiconductor film. Specifically, a selection signal can be supplied at a frequency of lower than 30 Hz, preferably lower than 1 Hz, further preferably less than once per minute while the occurrence of flickers is inhibited. Consequently, fatigue accumulation in a user of a data processing device can be reduced. Moreover, power consumption for driving can be reduced.

For example, a transistor using an oxide semiconductor can be used. Specifically, an oxide semiconductor containing indium or an oxide semiconductor containing indium, gallium, and zinc can be used for the semiconductor film.

For example, a transistor having a lower leakage current in an off state than a transistor that uses amorphous silicon for a semiconductor film can be used. Specifically, a transistor that uses an oxide semiconductor for a semiconductor film can be used.

For example, a 25-nm-thick film containing indium, gallium, and zinc can be used as the semiconductor film 508.

For example, a conductive film in which a 10-nm-thick film containing tantalum and nitrogen and a 300-nm-thick film containing copper are stacked can be used as the conductive film 504. Note that the film containing tantalum and nitrogen is positioned between a region of the film containing copper and the insulating film 506.

For example, a stacked-layer film in which a 400-nm-thick film containing silicon and nitrogen and a 200-nm-thick film containing silicon, oxygen, and nitrogen are stacked can be used as the insulating film 506. Note that the film containing silicon, oxygen, and nitrogen is positioned between a region of the film containing silicon and nitrogen and the semiconductor film 508.

For example, a conductive film in which a 50-nm-thick film containing tungsten, a 400-nm-thick film containing aluminum, and a 100-nm-thick film containing titanium are stacked in this order can be used as the conductive film 512A or the conductive film 512B. Note that the film containing tungsten includes a region in contact with the semiconductor film 508.

A manufacturing line for a bottom-gate transistor that uses amorphous silicon as a semiconductor can be easily remodeled into a manufacturing line for a bottom-gate transistor that uses an oxide semiconductor as a semiconductor, for example. Furthermore, for example, a manufacturing line for a top-gate transistor that uses polysilicon as a semiconductor can be easily remodeled into a manufacturing line for a top-gate transistor that uses an oxide semiconductor as a semiconductor. In either remodeling, an existing manufacturing line can be effectively utilized.

Thus, flickering can be inhibited. The power consumption can be reduced. Fast moving images can be smoothly displayed. A photograph and the like can be displayed with a wide range of grayscale. As a result, a novel display panel that is highly convenient or reliable can be provided.

### <<Structure Example 3 of Semiconductor Film 508>>

For example, a compound semiconductor can be used for the semiconductor film of the transistor. Specifically, a semiconductor containing gallium arsenide can be used for the semiconductor film.

For example, an organic semiconductor can be used for the semiconductor film of the transistor. Specifically, an organic semiconductor containing polyacene or graphene can be used for the semiconductor film.

<<Structure Example 2 of Pixel Circuit 530(i,j)>>

Another structure of the pixel circuit of one embodiment of the present invention is described with reference to FIG. 4C.

The pixel circuit 530(i,j) in FIG. 4(C) is different from the structure described with reference to FIG. 4B in including a capacitor C12 and a switch SW12. Different structures will be described in detail here, and the above description is referred to for portions that can use similar structures.

### <<Structure Example of Capacitor C12>>

The capacitor C12 includes a first terminal electrically connected to a node N1(i,j). The capacitor C12 also includes a second terminal electrically connected to the switch SW12.

### <<Structure Example of Switch SW12>>

The switch SW12 includes a first terminal to which a control signal is supplied. The switch SW12 also includes a second terminal electrically connected to the node N1(i,j). For example, a transistor can be used as the switch SW12. One of a source electrode and a drain electrode of the transistor can be used as the first terminal, and the other can be used as the second terminal.

The switch SW12 is in the conduction state when the switch SW1 changes from the conduction state to the non-conduction state. The switch SW12 has a function of changing from the non-conduction state to the conduction state when the switch SW1 is in the non-conduction state. The switch SW12 also has a function of changing from the conduction state to the non-conduction state when the switch SW1 is in the non-conduction state.

For example, the conduction state of the switch SW1 or the switch SW12, as which the transistor is used, can be controlled with the potential of a gate electrode of the transistor.

Thus, the potential of the node N1(i,j) can be controlled with the switch SW1. A change in the potential of the node N1(i,j) can be promoted or emphasized temporarily with the switch SW12. An offset voltage can be applied to the node N1(i,j). In the case where a liquid crystal display element is used as the display element 750(i,j), what is called overdriving is possible. The operation speed of the liquid crystal display element can be increased. The liquid crystal display element can be driven with the potential of the node N1(i,j) to which an offset voltage is added. As a result, a novel display panel that is highly convenient or reliable can be provided.

### <<Structure Example 2 of Functional Layer 520>>

The functional layer 520 includes an insulating film 521A, an insulating film 518, an insulating film 516 (an insulating film 516A and an insulating film 516B), the insulating film 506, an insulating film 501C, and the like (see FIG. 5A and FIG. 5B).

The insulating film 521A includes a region positioned between the pixel circuit 530(i,j) and the display element 750(i,j).

The insulating film 518 includes a region positioned between the insulating film 521A and the insulating film 501C.

The insulating film 516 includes a region positioned between the insulating film 518 and the insulating film 501C.

The insulating film 506 includes a region positioned between the insulating film 516 and the insulating film 501C.

### [Insulating Film 521A]

For example, an insulating inorganic material, an insulating organic material, or an insulating composite material containing an inorganic material and an organic material can be used for the insulating film 521A.

Specifically, an inorganic oxide film, an inorganic nitride film, an inorganic oxynitride film, or the like, or a layered material in which a plurality of films selected from these films are stacked can be used as the insulating film 521A.

For example, a silicon oxide film, a silicon nitride film, a silicon oxynitride film, an aluminum oxide film, or the like, or a film including a layered material in which a plurality of films selected from these films are stacked can be used as the insulating film 521A. Note that the silicon nitride film is a dense film and has an excellent function of inhibiting diffusion of impurities.

For example, polyester, polyolefin, polyamide, polyimide, polycarbonate, polysiloxane, an acrylic resin, or the like, or a layered material, a composite material, or the like of a plurality of resins selected from these resins can be used for the insulating film 521A. A photosensitive material may also be used. Thus, the insulating film 521A can planarize level differences due to various components overlapping with the insulating film 521A, for example.

Note that polyimide is excellent in thermal stability, insulating property, toughness, low dielectric constant, low coefficient of thermal expansion, chemical resistance, and other properties compared with other organic materials. Hence, in particular, polyimide can be suitably used for the insulating film 521A or the like.

For example, a film formed using a photosensitive material can be used as the insulating film 521A. Specifically, a film formed using photosensitive polyimide, a photosensitive acrylic resin, or the like can be used as the insulating film 521A.

### [Insulating Film 518]

For example, the material that can be used for the insulating film 521A can be used for the insulating film 518.

For example, a material that has a function of inhibiting diffusion of oxygen, hydrogen, water, an alkali metal, an alkaline earth metal, and the like can be used for the insulating film 518. Specifically, a nitride insulating film can be used as the insulating film 518. For example, silicon nitride, silicon nitride oxide, aluminum nitride, or aluminum nitride oxide can be used for the insulating film 518. Thus, diffusion of impurities into a semiconductor film of a transistor can be inhibited.

### [Insulating Film 516]

For example, the material that can be used for the insulating film 521A can be used for the insulating film 516.

Specifically, a film formed by a fabrication method different from that of the insulating film 518 can be used as the insulating film 516.

### [Insulating Film 506]

For example, the material that can be used for the insulating film 521A can be used for the insulating film 506.

Specifically, a film including a silicon oxide film, a silicon oxynitride film, a silicon nitride oxide film, a silicon nitride film, an aluminum oxide film, a hafnium oxide film, an yttrium oxide film, a zirconium oxide film, a gallium oxide film, a tantalum oxide film, a magnesium oxide film, a lanthanum oxide film, a cerium oxide film, or a neodymium oxide film can be used as the insulating film 506.

### [Insulating Film 501D]

An insulating film 501D includes a region positioned between the insulating film 501C and the insulating film 516.

For example, the material that can be used for the insulating film 506 can be used for the insulating film 501D.

### [Insulating Film 501C]

For example, the material that can be used for the insulating film 521A can be used for the insulating film 501C. Specifically, a material containing silicon and oxygen can be used for the insulating film 501C. Thus, diffusion of impurities into the pixel circuit, the display element, or the like can be inhibited.

### <Structure Example 2 of Display Panel 700>

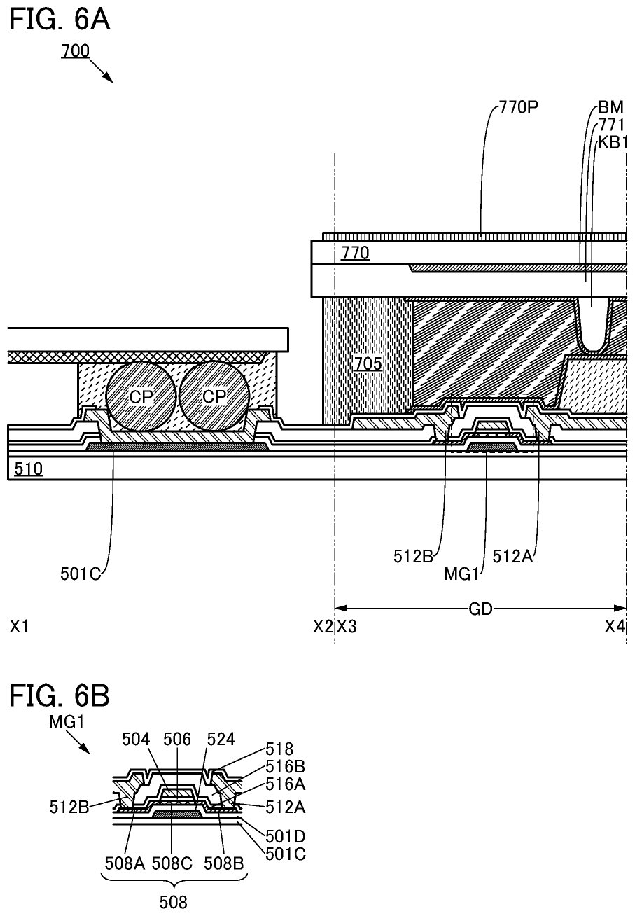

The display panel 700 includes a base material 510, a base material 770, and a sealant 705 (see FIG. 5A and FIG. 6A).

### <<Base Material 510 and Base Material 770>>

A light-transmitting material can be used for the base material 510 or the base material 770.

For example, a flexible material can be used for the base material 510 or the base material 770. Thus, a flexible display panel can be provided.

For example, a material with a thickness less than or equal to 0.7 mm and greater than or equal to 0.1 mm can be used for the base material 510 or the base material 770. Specifically, a material polished to a thickness of approximately 0.1 mm can be used. This can reduce the weight of the base material 510 or the base material 770.

For example, a glass substrate of the 6th generation (1500 mm×1850 mm), the 7th generation (1870 mm×2200 mm), the 8th generation (2200 mm×2400 mm), the 9th generation (2400 mm×2800 mm), the 10th generation (2950 mm×3400 mm), or the like can be used as the base material 510 or the base material 770. Thus, a large-sized display device can be manufactured.

An organic material, an inorganic material, a composite material of an organic material and an inorganic material or the like can be used for the base material 510 or the base material 770, for example.

For example, an inorganic material such as glass, ceramic, or a metal can be used. Specifically, non-alkali glass, soda-lime glass, potash glass, crystal glass, aluminosilicate glass, tempered glass, chemically tempered glass, quartz, or sapphire can be used for the base material 510 or the base material 770. Alternatively, aluminosilicate glass, tempered glass, chemically tempered glass, sapphire, or the like can be suitably used for the base material 510 or the base material 770 that is provided on the side close to a user of the display panel. Thus, the display panel can be prevented from being broken or damaged by the use thereof.

Specifically, an inorganic oxide film, an inorganic nitride film, an inorganic oxynitride film, or the like can be used as the base material 510 or the base material 770. For example, a silicon oxide film, a silicon nitride film, a silicon oxynitride film, or an aluminum oxide film can be used. Stainless steel, aluminum, or the like can be used for the base material 510 or the base material 770.

For example, a single crystal semiconductor substrate of silicon or silicon carbide, a polycrystalline semiconductor substrate, a compound semiconductor substrate of silicon germanium or the like, or an SOI substrate can be used as the base material 510 or the base material 770. Thus, a semiconductor element can be formed over the base material 510 or the base material 770.

For example, an organic material such as a resin, a resin film, or plastic can be used for the base material 510 or the base material 770. Specifically, a material containing polyester, polyolefin, polyamide (nylon, aramid, or the like), polyimide, polycarbonate, polyurethane, an acrylic resin, an epoxy resin, or a resin having a siloxane bond can be used for the base material 510 or the base material 770. For example, a resin film, a resin plate, a stacked-layer material, or the like containing any of these materials can be used. As a result, the weight can be reduced. For example, the frequency of occurrence of breakage due to dropping or the like can be reduced.

Specifically, polyethylene terephthalate (PET), polyethylene naphthalate (PEN), polyethersulfone (PES), a cycloolefin polymer (COP), a cycloolefin copolymer (COC), or the like can be used for the base material 510 or the base material 770.

For example, a composite material formed by attaching a metal plate, a thin glass plate, or a film of an inorganic material or the like to a resin film or the like can be used for the base material 510 or the base material 770. For example, a composite material formed by dispersing a fibrous or particulate metal, glass, an inorganic material, or the like into a resin can be used for the base material 510 or the base material 770. For example, a composite material formed by dispersing a fibrous or particulate resin, an organic material, or the like into an inorganic material can be used for the base material 510 or the base material 770.

A single-layer material or a material in which a plurality of layers are stacked can be used for the base material 510 or the base material 770. For example, a material in which insulating films and the like are stacked can be used for the base material 510 or the base material 770. Specifically, a material in which one or a plurality of films selected from a silicon oxide layer, a silicon nitride layer, a silicon oxynitride layer, and the like are stacked can be used for the base material 510 or the base material 770. Thus, diffusion of impurities contained in the base material can be prevented, for example. Diffusion of impurities contained in glass or a resin can be prevented. Diffusion of impurities that pass through a resin can be prevented.

Furthermore, paper, wood, or the like can be used for the base material 510 or the base material 770.

For example, a material having heat resistance high enough to withstand heat treatment in the manufacturing process can be used for the base material 510 or the base material 770. Specifically, a material that is resistant to heat applied in the process of directly forming the transistor, the capacitor, or the like can be used for the base material 510 or the base material 770.

For example, it is possible to use a method in which an insulating film, a transistor, a capacitor, or the like is formed over a process substrate that is resistant to heat applied in the manufacturing process, and then the formed insulating film, transistor, capacitor, or the like is transferred to the base material 510 or the base material 770. Thus, the insulating film, the transistor, the capacitor, or the like can be formed over a flexible substrate, for example.

### <<Sealant 705>>

The sealant 705 includes a region positioned between the base material 510 and the base material 770, and has a function of bonding the base material 510 and the base material 770 together (see FIG. 6A).

For the sealant 705, an inorganic material, an organic material, a composite material of an inorganic material and an organic material, or the like can be used.

For example, an organic material such as a thermally fusible resin or a curable resin can be used for the sealant 705.

For example, an organic material such as a reactive curable adhesive, a light curable adhesive, a thermosetting adhesive, and/or an anaerobic adhesive can be used for the sealant 705.

Specifically, an adhesive containing an epoxy resin, an acrylic resin, a silicone resin, a phenol resin, a polyimide resin, an imide resin, a PVC (polyvinyl chloride) resin, a PVB (polyvinyl butyral) resin, an EVA (ethylene vinyl acetate) resin, or the like can be used for the sealant 705.

### <Structure Example 3 of Display Panel 700>

The display panel 700 includes a functional film 770P (see FIG. 5A).

### <<Functional Film 770P and the Like>>

The functional film 770P includes a region overlapping with the display element 750(i,j).

For example, an anti-reflection film, a polarizing film, a retardation film, a light diffusion film, a condensing film, or the like can be used as the functional film 770P.

For example, an anti-reflection film with a thickness of 1 μm or less can be used as the functional film 770P. Specifically, a stacked-layer film in which three or more layers, preferably five or more layers, further preferably 15 or more layers of dielectrics are stacked can be used as the functional film 770P. This allows the reflectivity to be as low as 0.5% or less, preferably 0.08% or less.

Furthermore, an antistatic film that inhibits the attachment of dust, a water-repellent film that inhibits the attachment of a stain, an antireflective film (anti-reflection film), a non-glare film (anti-glare film), a hard coat film that inhibits the generation of a scratch in use, or the like can be used as the functional film 770P.

### <Structure Example 4 of Display Panel 700>

The display panel 700 includes a structure body KB1.

### <<Structure Body KB1>>

The structure body KB1 has a function of providing a predetermined space between the functional layer 520 and the base material 770.

<<Structure Example of Display Element 750(i,j)>>

For example, the display element 750(i,j) has a function of controlling light scattering or transmission. Specifically, the liquid crystal element 75 described in Embodiment 2 can be used as the display element 750(i,j).

The display element 750(i,j) includes a layer 753 containing a liquid crystal material (see FIG. 5A).

Thus, images can be displayed by the control of light scattering or transmission. Scenery or the like can be observed through the display element 750(i,j). An image overlapping with scenery can be displayed. For example, images can be displayed by scattering of light emitted from a sidelight.

<<Structure Example 2 of Display Element 750(i,j)>>

The display element 750(i,j) includes an electrode 751(i,j), an electrode 752, and the layer 753 containing a liquid crystal material.

The electrode 751(i,j) is electrically connected to the pixel circuit 530(i,j) in the opening portion 591A.

The electrode 752 is arranged so that an electric field controlling the alignment of the liquid crystal material is formed between the electrode 751(i,j) and the electrode 752.

The display element 750(i,j) includes the alignment film AF1 and the alignment film AF2.

### <<Layer 753 Containing Liquid Crystal Material>>

The layer 753 containing a liquid crystal material includes a region positioned between the alignment film AF1 and the alignment film AF2.

For example, a liquid crystal material having a resistivity greater than or equal to 1.0×10¹³ Ω·cm, preferably greater than or equal to 1.0×10¹⁴ Ω·cm, further preferably greater than or equal to 1.0×10¹⁵ Ω·cm can be used for the layer 753 containing a liquid crystal material. This can inhibit a variation in the transmittance of the display element 750(i,j). Flickering of the display element 750(i,j) can be inhibited. The rewriting frequency of the display element 750(i,j) can be reduced.

Note that this embodiment can be combined with the other embodiments in this specification as appropriate.

### Embodiment 4

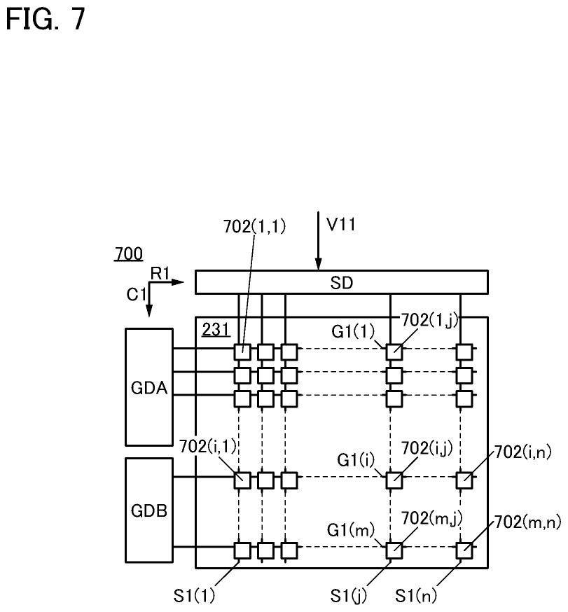

In this embodiment, a structure of a display panel of one embodiment of the present invention will be described with reference to FIG. 6 and FIG. 7.

FIG. 7 is a block diagram illustrating the structure of the display panel of one embodiment of the present invention.

### <Structure Example 4 of Display Panel>

The display panel 700 described in this embodiment includes the display area 231 (see FIG. 7).

### <<Structure Example 1 of Display Area 231>>

The display area 231 includes a group of pixels 702(i,1) to 702(i,n), a different group of pixels 702(1,i) to 702(m,j), the scan line G1(i), and a signal line S1(j) (see FIG. 7). Note that i is an integer greater than or equal to 1 and less than or equal to m,j is an integer greater than or equal to 1 and less than or equal to n, and m and n are each an integer greater than or equal to 1.

Although not illustrated, the display area 231 includes a conductive film VCOM1.

The group of pixels 702(i,1) to 702(i,n) is arranged in a row direction (the direction indicated by an arrow R1 in the drawing) and includes the pixel 702(i,j).

The different group of pixels 702(1,j) to 702(m,j) is arranged in a column direction intersecting the row direction (the direction indicated by an arrow Cl in the drawing) and includes the pixel 702(i,j).

The scan line G1(i) is electrically connected to the group of pixels 702(i,1) to 702(i,n) arranged in the row direction.

The signal line S1(j) is electrically connected to the different group of pixels 702(1,j) to 702(m,j) arranged in the column direction.

Thus, image data can be supplied to a plurality of pixels. As a result, a novel display panel that is highly convenient or reliable can be provided.

### <Structure Example 5 of Display Panel>

The display panel 700 described in this embodiment includes one or more driver circuits. For example, a driver circuit GDA, a driver circuit GDB, or a driver circuit SD can be included (see FIG. 7).

### <<Driver Circuit GDA and Driver Circuit GDB>>

The driver circuit GDA and the driver circuit GDB can be used as a driver circuit GD. For example, the driver circuit GDA and the driver circuit GDB have a function of supplying a selection signal on the basis of control data.

Specifically, the driver circuit GDA and the driver circuit GDB have a function of supplying a selection signal to one scan line at a frequency higher than or equal to 30 Hz, preferably higher than or equal to 60 Hz, on the basis of the control data. Thus, a moving image can be smoothly displayed.

Alternatively, the driver circuit GDA and the driver circuit GDB have a function of supplying a selection signal to one scan line at a frequency lower than 30 Hz, preferably lower than 1 Hz, further preferably less than once a minute, on the basis of the control data. Thus, a still image with reduced flickering can be displayed.

In the case where a plurality of driver circuits are provided, for example, the frequency at which the driver circuit GDA supplies a selection signal and the frequency at which the driver circuit GDB supplies a selection signal can be made different from each other. Specifically, the selection signal can be supplied at a higher frequency to a region where a moving image is displayed than to a region where a still image is displayed. Thus, a still image with reduced flickering can be displayed on a region, and a moving image can be smoothly displayed on another region.

The frame frequency can be variable. For example, display can be performed at a frame frequency higher than or equal to 1 Hz and lower than or equal to 120 Hz. Alternatively, display can be performed at a frame frequency of 120 Hz by a progressive method.

For example, a bottom-gate transistor or a top-gate transistor can be used in the driver circuit GD. Specifically, a transistor MG1 can be used in the driver circuit GD (see FIG. 6A and FIG. 6B).

Note that, for example, a semiconductor film used in a transistor of the driver circuit GD can be formed in a step of forming a semiconductor film used in a transistor of the pixel circuit 530(i,j).

### <<Driver Circuit SD>>

The driver circuit SD has a function of generating an image signal on the basis of data V11 and a function of supplying the image signal to a pixel circuit electrically connected to one display element (see FIG. 7).

For example, a variety of sequential circuits such as a shift register can be used as the driver circuit SD.

For example, an integrated circuit formed on a silicon substrate can be used as the driver circuit SD.

For example, an integrated circuit can be connected to a terminal by a COG (Chip on glass) method or a COF (Chip on Film) method. Specifically, an anisotropic conductive film can be used to connect an integrated circuit to a terminal.

Note that this embodiment can be combined with the other embodiments in this specification as appropriate.

### Embodiment 5

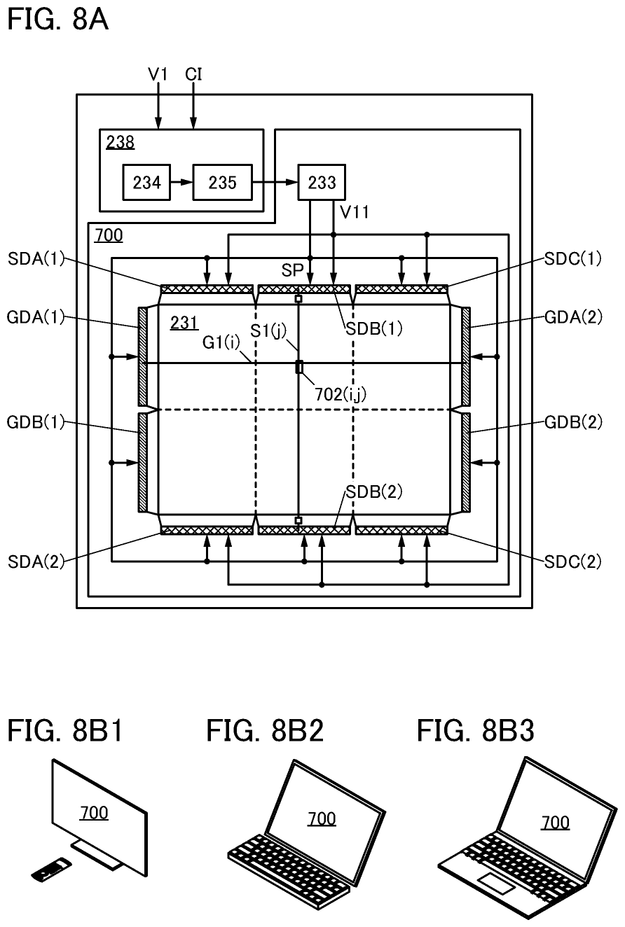

In this embodiment, a structure of a display device of one embodiment of the present invention will be described with reference to FIG. 8.

FIG. 8 illustrates the structure of the display device of one embodiment of the present invention. FIG. 8A is a block diagram of the display device of one embodiment of the present invention, and FIG. 8B1 to FIG. 8B3 are projection views illustrating the appearance of the display device of one embodiment of the present invention.

### <Structure Example of Display Device>

The display device described in this embodiment includes a control unit 238 and the display panel 700 (see FIG. 8A).

### <<Structure Example of Control Unit 238>>

The image data V1 and control data CI are supplied to the control unit 238. For example, a clock signal or a timing signal can be used as the control data CI.

The control unit 238 generates the data V11 on the basis of the image data V1 and generates a control signal SP on the basis of the control data CI. Furthermore, the control unit 238 supplies the data V11 and the control signal SP.

The data V11 includes, for example, a grayscale of 8 bits or more, preferably 12 bits or more. For example, a clock signal, a start pulse, or the like of a shift register used for a driver circuit can be used as the control signal SP.

Specifically, the control unit 238 includes a decompression circuit 234 and an image processing circuit 235.

### <<Decompression Circuit 234>>

The decompression circuit 234 has a function of decompressing the image data V1 supplied in a compressed state. The decompression circuit 234 includes a memory unit. The memory unit has a function of, for example, storing decompressed image data.

### <<Image Processing Circuit 235>>

The image processing circuit 235 includes, for example, a memory region. The memory region has a function of, for example, storing data included in the image data V1.

The image processing circuit 235 has a function of, for example, correcting the image data V1 on the basis of a predetermined characteristic curve to generate the data V11 and a function of supplying the data V11.

### <<Structure Example of Display Panel>>

The data V11 and the control signal SP are supplied to the display panel 700. The display panel 700 includes the driver circuit GD. For example, the display panel 700 described in Embodiment 3 can be used.

For example, a control circuit 233 can be used in the display panel 700. The driver circuit GD can be used in the display panel 700.

### <<Control Circuit 233>>

The control circuit 233 has a function of generating and supplying the control signal SP. For example, a clock signal or a timing signal can be used as the control signal SP. Specifically, a timing controller can be used as the control circuit 233.

For example, the control circuit 233 formed over a rigid substrate can be used in the display panel 700. The control circuit 233 formed over a rigid substrate can be electrically connected to the control unit 238 with the use of a flexible printed board.

### <<Driver Circuit GD>>

The driver circuit GD operates on the basis of the control signal SP.

For example, a driver circuit GDA(1), a driver circuit GDA(2), a driver circuit GDB(1), and a driver circuit GDB(2) have a function of receiving the control signal SP and supplying a selection signal.

For example, a driver circuit SDA(1), a driver circuit SDA(2), a driver circuit SDB(1), a driver circuit SDB(2), a driver circuit SDC(1), and a driver circuit SDC(2) are capable of receiving the control signal SP and the data V11 and supplying an image signal.

Using the control signal SP enables a synchronized operation of a plurality of driver circuits.

<<Structure Example of Pixel 702(i,j)>>

The pixel 70201) performs display on the basis of the data V11.

Thus, the image data can be displayed using a display element. As a result, a novel display device that is highly convenient or reliable can be provided. For example, a television receiver system (see FIG. 8B1), a video monitor (see FIG. 8B2), or a laptop computer (see FIG. 8B3) can be provided.

Note that this embodiment can be combined with the other embodiments in this specification as appropriate.

### Embodiment 6

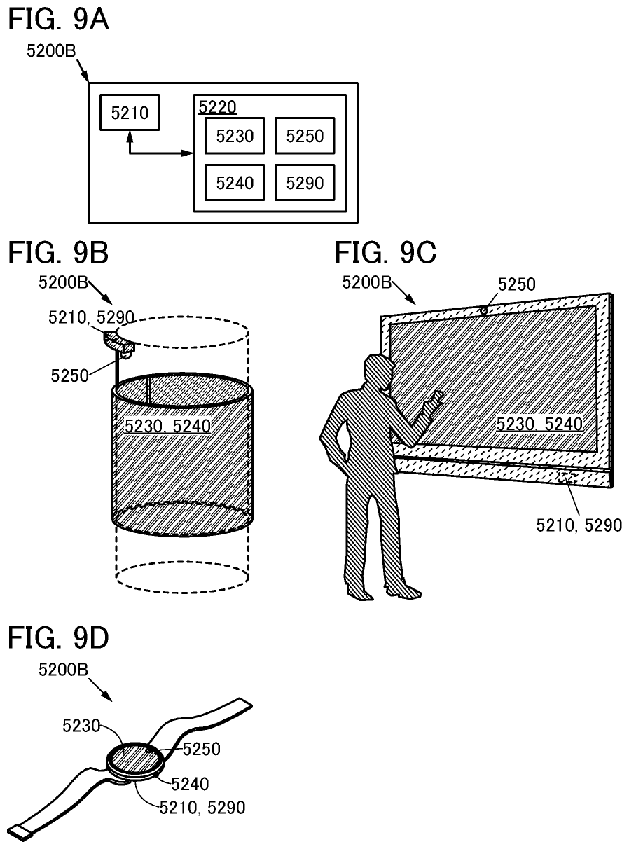

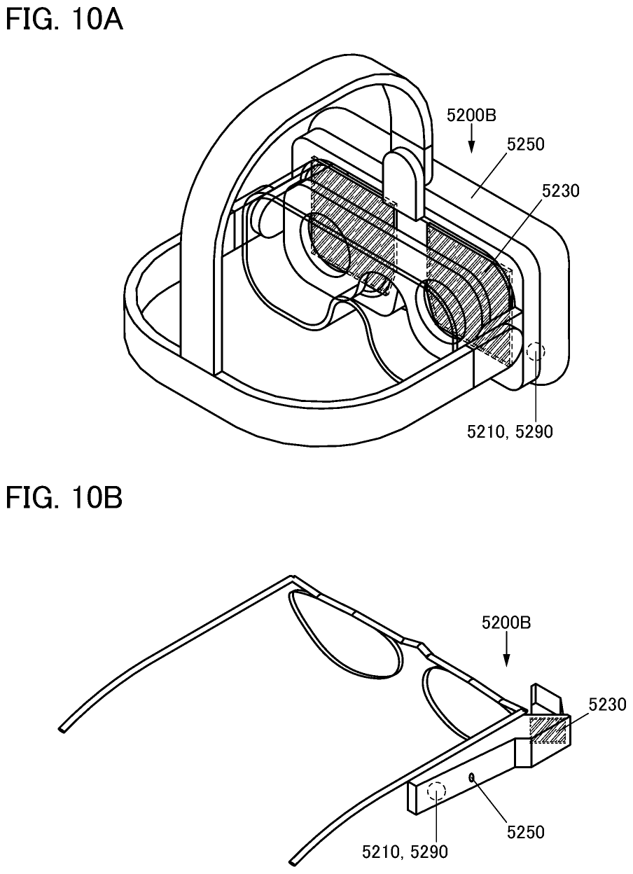

In this embodiment, structures of a data processing device of one embodiment of the present invention will be described with reference to FIG. 9 and FIG. 10.

FIG. 9 and FIG. 10 are diagrams illustrating the structures of the data processing device of one embodiment of the present invention. FIG. 9A is a block diagram of the data processing device, and FIG. 9B to FIG. 9D are perspective views illustrating the structures of the data processing device. FIG. 10A and FIG. 10B are perspective views illustrating the structures of the data processing device.

### <Data Processing Device>

A data processing device 5200B described in this embodiment includes an arithmetic device 5210 and an input/output device 5220 (see FIG. 9A).

The arithmetic device 5210 has a function of receiving operation data and a function of supplying image data on the basis of the operation data.

The input/output device 5220 includes a display unit 5230, an input unit 5240, a sensing unit 5250, and a communication unit 5290 and has a function of supplying operation data and a function of receiving image data. The input/output device 5220 also has a function of supplying sensing data, a function of supplying communication data, and a function of receiving communication data.

The input unit 5240 has a function of supplying operation data. For example, the input unit 5240 supplies operation data on the basis of operation by a user of the data processing device 5200B.

Specifically, a keyboard, a hardware button, a pointing device, a touch sensor, an illuminance sensor, an imaging device, an audio input device, an eye-gaze input device, an attitude detection device, or the like can be used in the input unit 5240.

The display unit 5230 includes a display panel and has a function of displaying image data. For example, the display panel described in Embodiment 1 can be used for the display unit 5230.

The sensing unit 5250 has a function of supplying sensing data. For example, the sensing unit 5250 has a function of sensing a surrounding environment where the data processing device is used and supplying sensing data.

Specifically, an illuminance sensor, an imaging device, an attitude detection device, a pressure sensor, a human motion sensor, or the like can be used in the sensing unit 5250.

The communication unit 5290 has a function of receiving communication data and a function of supplying communication data. For example, the communication unit 5290 has a function of being connected to another electronic device or a communication network through wireless communication or wired communication. Specifically, the communication unit 5290 has a function of wireless local area network communication, telephone communication, near field communication, or the like.

### <<Structure Example 1 of Data Processing Device>>

For example, the display unit 5230 can have an outer shape along a cylindrical column or the like (see FIG. 9B). The data processing device has a function of changing its display method in accordance with the illuminance of a usage environment. Furthermore, the data processing device has a function of changing displayed content in response to sensed existence of a person. Thus, the data processing device can be provided on a column of a building, for example. The data processing device can display advertising, guidance, or the like. The data processing device can be used for digital signage or the like.

### <<Structure Example 2 of Data Processing Device>>

For example, the data processing device has a function of generating image data on the basis of the path of a pointer used by a user (see FIG. 9C). Specifically, a display panel with a diagonal size of 20 inches or longer, preferably 40 inches or longer, further preferably 55 inches or longer can be used. Alternatively, a plurality of display panels can be arranged and used as one display area. Alternatively, a plurality of display panels can be arranged and used as a multiscreen. Thus, the data processing device can be used for an electronic blackboard, an electronic bulletin board, or digital signage, for example.

### <<Structure Example 3 of Data Processing Device>>

The data processing device can receive data from another device and display the data on the display unit 5230 (see FIG. 9D). Several options can be displayed. The user can choose some from the options and send a reply to a transmitter of the data. For example, the data processing device has a function of changing its display method in accordance with the illuminance of a usage environment. Thus, for example, the power consumption of a smartwatch can be reduced. For another example, a smartwatch can display an image so as to be suitably used even in an environment under strong external light, e.g., outdoors in fine weather.

### <<Structure Example 4 of Data Processing Device>>

The data processing device includes, for example, the sensing unit 5250 that senses an acceleration or a direction (see FIG. 10A). The sensing unit 5250 can supply data on the position of the user or the direction in which the user faces. The data processing device can generate image data for the right eye and image data for the left eye in accordance with the position of the user or the direction in which the user faces. The display unit 5230 includes a display area for the right eye and a display area for the left eye. Thus, a virtual reality image that gives the user a sense of immersion can be displayed on a goggles-type data processing device, for example.

### <<Structure Example 5 of Data Processing Device>>

The data processing device includes, for example, an imaging device and the sensing unit 5250 that senses an acceleration or a direction (see FIG. 10B). The sensing unit 5250 can supply data on the position of the user or the direction in which the user faces. The data processing device can generate image data in accordance with the position of the user or the direction in which the user faces. Thus, the data can be shown together with a real-world scene, for example. An augmented reality image can be displayed on a glasses-type data processing device.

Note that this embodiment can be combined with the other embodiments in this specification as appropriate.

For example, in this specification and the like, when there is a description which explicitly states that X and Y are connected, the case where X and Y are electrically connected, the case where X and Y are functionally connected, and the case where X and Y are directly connected are regarded as being disclosed in this specification and the like. Accordingly, without being limited to a predetermined connection relation, e.g., a connection relation shown in drawings or texts, a connection relation other than one shown in drawings or texts is regarded as being disclosed in the drawings or the texts.

Here, X and Y each denote an object (e.g., a device, an element, a circuit, a wiring, an electrode, a terminal, a conductive film, or a layer).

An example of the case where X and Y are directly connected is the case where an element that enables electrical connection between X and Y (e.g., a switch, a transistor, a capacitor, an inductor, a resistor, a diode, a display element, a light-emitting element, or a load) is not connected between X and Y, i.e., the case where X and Y are connected without an element that enables electrical connection between X and Y (e.g., a switch, a transistor, a capacitor, an inductor, a resistor, a diode, a display element, a light-emitting element, or a load).

An example of the case where X and Y are electrically connected is the case where at least one element that enables electrical connection between X and Y (e.g., a switch, a transistor, a capacitor, an inductor, a resistor, a diode, a display element, a light-emitting element, or a load) can be connected between X and Y. Note that a switch has a function of being controlled to be turned on or off That is, the switch has a function of controlling whether current flows or not by being in a conduction state (an on state) or a non-conduction state (an off state). Alternatively, the switch has a function of selecting and changing a current path. Note that the case where X and Y are electrically connected includes the case where X and Y are directly connected.

For example, in the case where X and Y are functionally connected, one or more circuits that enable functional connection between X and Y (for example, a logic circuit (an inverter, a NAND circuit, a NOR circuit, or the like); a signal converter circuit (a DA converter circuit, an AD converter circuit, a gamma correction circuit, or the like); a potential level converter circuit (a power supply circuit (a step-up circuit, a step-down circuit, or the like), a level shifter circuit for changing the potential level of a signal, or the like); a voltage source; a current source; a switching circuit; an amplifier circuit (a circuit that can increase signal amplitude, the amount of current, or the like, an operational amplifier, a differential amplifier circuit, a source follower circuit, a buffer circuit, or the like); a signal generation circuit; a memory circuit; or a control circuit) can be connected between X and Y. Note that, for example, even when another circuit is interposed between X and Y, X and Y are functionally connected if a signal output from X is transmitted to Y. Note that the case where X and Y are functionally connected includes the case where X and Y are directly connected and the case where X and Y are electrically connected.

Note that when there is a description which explicitly states that X and Y are electrically connected, the case where X and Y are electrically connected (that is, the case where X and Y are connected with another element or another circuit provided therebetween), the case where X and Y are functionally connected (that is, the case where X and Y are functionally connected with another circuit provided therebetween), and the case where X and Y are directly connected (that is, the case where X and Y are connected without another element or another circuit provided therebetween) are regarded as being disclosed in this specification and the like. That is, when there is an explicit description, being electrically connected, the same contents as the case where there is only an explicit description, being connected, are disclosed in this specification and the like.

Note that, for example, the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to one part of Z1 and another part of Z1 is directly connected to X while a drain (or a second terminal or the like) of the transistor is directly connected to one part of Z2 and another part of Z2 is directly connected to Y can be expressed as follows.

It can be expressed as, for example, “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”. Alternatively, it can be expressed as “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”. Alternatively, it can be expressed as “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided in this connection order”. When the connection order in a circuit configuration is defined by using an expression similar to these examples, a source (or a first terminal or the like) and a drain (or a second terminal or the like) of a transistor can be distinguished from each other to specify the technical scope.

It can also be expressed as “a source (or a first terminal or the like) of a transistor is electrically connected to X through at least a first connection path, the first connection path does not include a second connection path, the second connection path is a path through the transistor and between the source (or the first terminal or the like) of the transistor and a drain (or a second terminal or the like) of the transistor, the first connection path is a path through Z1, the drain (or the second terminal or the like) of the transistor is electrically connected to Y through at least a third connection path, the third connection path does not include the second connection path, and the third connection path is a path through Z2”. Alternatively, it can be expressed as “a source (or a first terminal or the like) of a transistor is electrically connected to X through Z1 by at least a first connection path, the first connection path does not include a second connection path, the second connection path includes a connection path through the transistor, a drain (or a second terminal or the like) of the transistor is electrically connected to Y through Z2 by at least a third connection path, and the third connection path does not include the second connection path”. Alternatively, it can be expressed as “a source (or a first terminal or the like) of a transistor is electrically connected to X through Z1 by at least a first electrical path, the first electrical path does not include a second electrical path, the second electrical path is an electrical path from the source (or the first terminal or the like) of the transistor to a drain (or a second terminal or the like) of the transistor, the drain (or the second terminal or the like) of the transistor is electrically connected to Y through Z2 by at least a third electrical path, the third electrical path does not include a fourth electrical path, and the fourth electrical path is an electrical path from the drain (or the second terminal or the like) of the transistor to the source (or the first terminal or the like) of the transistor”. When the connection path in a circuit configuration is defined by using an expression similar to these examples, a source (or a first terminal or the like) and a drain (or a second terminal or the like) of a transistor can be distinguished from each other to specify the technical scope.

Note that these expressions are examples and the expression is not limited to these expressions. Here, X, Y, Z1, and Z2 denote an object (e.g., a device, an element, a circuit, a wiring, an electrode, a terminal, a conductive film, a layer, or the like).

Note that even when independent components are electrically connected to each other in a circuit diagram, one component has functions of a plurality of components in some cases. For example, when part of a wiring also functions as an electrode, one conductive film has functions of both components: a function of the wiring and a function of the electrode. Thus, electrical connection in this specification includes in its category such a case where one conductive film has functions of a plurality of components.

### REFERENCE NUMERALS

AF1: alignment film, AF2: alignment film, C11: capacitor, C12: capacitor, CI: control data, G1: scan line, KB1: structure body, S1: signal line, SW1: switch, SW12: switch, V1: image data, V11: data, VCOM1: conductive film, 51: electrode, 52: electrode, 53: layer containing liquid crystal material, 75: liquid crystal element, 231: display area, 231A: display area, 231B: display area, 239A: margin area, 239B: margin area, 233: control circuit, 234: decompression circuit, 235: image processing circuit, 238: control unit, 501C: insulating film, 501D: insulating film, 504: conductive film, 506: insulating film, 508: semiconductor film, 508A: region, 508B: region, 508C: region, 510: base material, 512A: conductive film, 512B: conductive film, 516: insulating film, 518: insulating film, 520: functional layer, 521: insulating film, 524: conductive film, 530: pixel circuit, 591A: opening portion, 700: display panel, 702: pixel, 705: sealant, 750: display element, 751: electrode, 752: electrode, 753: layer containing liquid crystal material, 770: base material, 770P: functional film, 5200B: data processing device, 5210: arithmetic device, 5220: input/output device, 5230: display unit, 5240: input unit, 5250: sensing unit, 5290: communication unit

1. A display panel comprising:
a first display area;
a second display area;
a first margin area; and
a second margin area,
wherein the second display area is arranged continuously with the first display area,
wherein the first margin area is adjacent to the first display area,
wherein the second margin area is adjacent to the second display area,
wherein the second margin area faces the first margin area,
wherein the first display area comprises a pixel,
wherein the pixel comprises a pixel circuit and a display element,
wherein the display element is electrically connected to the pixel circuit, and
wherein the display element is configured to transmit or scatter incident light.

2. The display panel according to claim 1,
wherein the display element comprises a first electrode, a second electrode, a layer containing a liquid crystal material, a first alignment film, and a second alignment film,
wherein the first alignment film comprises a region positioned between the first electrode and the layer containing a liquid crystal material,
wherein the second alignment film comprises a region positioned between the second electrode and the layer containing a liquid crystal material,
wherein the second electrode is arranged so that an electric field crossing the layer containing a liquid crystal material is formed between the first electrode and the second electrode,
wherein the layer containing a liquid crystal material scatters the incident light with a first scattering intensity when the electric field is in a first state,
wherein the layer containing a liquid crystal material scatters the incident light with a second scattering intensity when the electric field is in a second state where the electric field is stronger than that in the first state,
wherein the second scattering intensity is higher than the first scattering intensity,
wherein the layer containing a liquid crystal material contains a liquid crystal material and a high molecular material,
wherein the layer containing a liquid crystal material is stabilized with the high molecular material,
wherein the high molecular material is a copolymer of a polyfunctional monomer and a monofunctional monomer,
wherein the polyfunctional monomer has a phenyl benzoate skeleton, and
wherein the monofunctional monomer has a cyclohexylbenzene skeleton.

3. The display panel according to claim 2,
wherein the second scattering intensity is 10 times or more the first scattering intensity.

4. The display panel according to claim 1,
wherein the first display area comprises a group of pixels, a different group of pixels, a scan line, and a signal line,
wherein the group of pixels comprises the pixel,
wherein the group of pixels is arranged in a row direction,
wherein the different group of pixels comprises the pixel,
wherein the different group of pixels is arranged in a column direction intersecting the row direction,
wherein the scan line is electrically connected to the group of pixels, and
wherein the signal line is electrically connected to the different group of pixels.

5. A display device comprising:
the display panel according to claim 1; and
a control unit,
wherein image data and control data are supplied to the control unit,
wherein the control unit generates data on the basis of the image data,
wherein the control unit generates a control signal on the basis of the control data,
wherein the control unit supplies the data and the control signal,
wherein the data and the control signal are supplied to the display panel,
wherein the display panel comprises a driver circuit,
wherein the driver circuit operates on the basis of the control signal, and
wherein the pixel performs display on the basis of the data.
